(19) United States
(12) Patent Application Publication
(10) Pub. No.: US 2004/0243523 A1
(43) Pub. Date: Dec. 2, 2004

(54) Mail item printing station, and mail item handling system and method

(75) Inventor: Raymond John Herbert, Leigh-on-Sea (GB)

Correspondence Address: SHOEMAKER AND MATTARE, LTD, 10 POST OFFICE ROAD - SUITE 110, SILVER SPRING, MD, 20910, US

(73) Assignee: Neopost Industrie SA, Bagneux (FR)

(21) Appl. No.: 10/768,708

(22) Filed: Feb. 2, 2004

(30) Foreign Application Priority Data
Jan. 31, 2003 (GB) 0302275.3

(51) Int. Cl. G06F 17/60

(52) U.S. Cl. 705/408; 705/401

(57) ABSTRACT

A mail item printing station for printing postage indicia on mail items, which postage indicia embody a normal postage service and an additional service for at least ones of the mail items, the printing station comprising: a printing unit for printing postage indicia on mail items; a control unit for controlling the printing unit and performing accounting functions, wherein the control unit includes a first memory for logging each event of the additional service as applied to the at least ones of the mail items; and a user interface for enabling user control of the printing station.

### FIELD OF THE INVENTION

The present invention relates to a mail item printing station for printing postage indicia on mail items, and a mail item handling system and method which provides for the application of a service, in particular an insurance service, in addition to the normal postage service.

### BACKGROUND OF THE INVENTION

Numerous postage metering systems exist which provide for the printing of postage indicia.

The present inventor has devised a mail item printing station and a mail item handling system and method which extends such existing systems to provide for the application of a service, in particular an insurance service, in addition to the normal postage service, in accounting for the provision of the additional service and enabling the authentication of that service to mail items.

### SUMMARY OF THE INVENTION

In one aspect the present invention provides a mail item printing station for printing postage indicia on mail items, which postage indicia embody a normal postage service and an additional service for at least ones of the mail items, the printing station comprising: a printing unit for printing postage indicia on mail items; a control unit for controlling the printing unit and performing accounting functions, wherein the control unit includes a first memory for logging each event of the additional service as applied to the at least ones of the mail items; and a user interface for enabling user control of the printing station.

Preferably, each logged event includes a mail item identifier.

Preferably, each logged event identifies a selected additional service.

Preferably, the first memory is a non-erasable memory.

Preferably, the control unit includes a second memory for storing a value of credit to be dispensed by the printing station.

In one embodiment the second memory comprises a first credit register which is representative of a value of credit available to be dispensed by the printing station in application of a normal postage charge in accordance with the normal postage service, and a second credit register which is representative of a value of credit available to be dispensed by the printing station in application of an additional service charge in accordance with the additional service.

In another embodiment the second memory comprises a single credit register which is representative of a value of credit available to be dispensed by the printing station in application of both a normal postage charge in accordance with the normal postage service and an additional service charge in accordance with the additional service.

Preferably, the control unit includes a third memory for storing at least one table defining additional service charges for the additional service.

Preferably, the additional service comprises an insurance service by which mail items are insured.

In one embodiment the insurance service can be selected by insured value.

In one embodiment the insurance service can be selected by geographic zone.

In one embodiment the insurance service can be selected by kind of insured goods, thereby not requiring the user to provide an indication as to value of replacement of the goods.

Preferably, the postage indicia embodying a normal postage service and an additional service each comprise first and second postage indicium elements, the first postage indicium element embodying normal postage information and the second postage indicium element embodying application of the additional service.

More preferably, the second postage indicium element includes an identifier for the mail item.

In one embodiment the second postage indicium element is cryptographically encoded.

In another aspect the present invention provides a mail item handling system, comprising: at least one printing station as above described.

Preferably, the at least one printing station comprises a communications unit, and further comprising: a control center in communication with the at least one printing station, the control center maintaining a record of at least the mail items having the additional service applied thereto.

More preferably, the at least one printing station is configured to allow a user to query the control center as regards a status of a mail item.

In a further aspect the present invention provides a method of handling mail items, comprising the steps of: providing a mail item printing station for printing postage indicia on mail items, wherein the printing station is operable, for any mail item, to allow a user to select an additional service in addition to a normal postage service; selecting an additional service for a mail item; logging the additional service as applied to the mail item; and printing a postage indicium on the mail item, which postage indicium embodies the normal postage service and the additional service.

Preferably, each logged event includes a mail item identifier.

Preferably, each logged event identifies a selected additional service.

Preferably, the logged events are logged in a non-erasable memory, such as to provide for authentication of the logged events.

Preferably, the method further comprises the step of: storing a value of credit available to be dispensed by the printing station.

In one embodiment the credit value storing step comprises the steps of: storing a first value of credit available to be dispensed by the printing station in application of a normal postage charge in accordance with the normal postage service; and storing a second value of credit available to be dispensed by the printing station in application of an additional service charge in accordance with the additional service.

Preferably, the method further comprises the step of: storing at least one table defining additional service charges for the additional service.

Preferably, the additional service comprises an insurance service by which mail items are insured.

In one embodiment the insurance service can be selected by insured value.

In one embodiment the insurance service can be selected by geographic zone.

In one embodiment the insurance service can be selected by kind of insured goods, thereby not requiring the user to provide an indication as to value of replacement of the goods.

Preferably, the postage indicia embodying a normal postage service and an additional service each comprise first and second postage indicium elements, the first postage indicium element embodying normal postage information and the second postage indicium element embodying application of the additional service.

More preferably, the second postage indicium element includes an identifier for the mail item.

In one embodiment the second postage indicium element is cryptographically encoded.

Preferably, the method further comprises the step of: maintaining at a control center a record of at least the mail items having the additional service applied thereto.

More preferably, the printing station is configured to allow a user to query the control center as regards a status of a mail item.

### BRIEF DESCRIPTION OF THE DRAWINGS

A preferred embodiment of the present invention will now be described hereinbelow by way of example only with reference to the accompanying drawings, in which:

FIG. 1 illustrates a mail item handling system in accordance with a preferred embodiment of the present invention; and

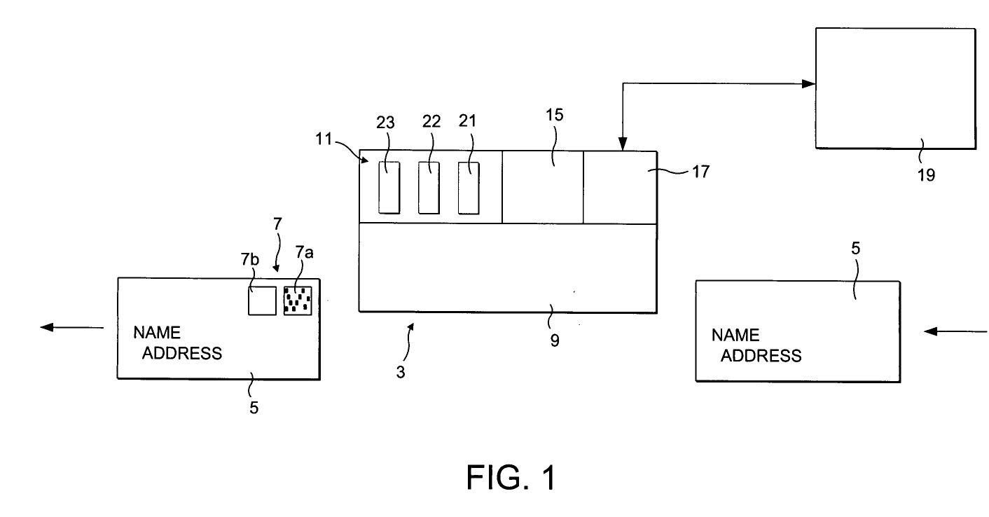

FIG. 2 represents an exemplary insurance event log for the mail item handling system of FIG. 1.

### DETAILED DESCRIPTION OF THE PREFERRED EMBODIMENT

The mail item handling system comprises at least one mail item printing station 3 for printing mail items 5, either directly or indirectly through labelling, with postage indicia 7. In preferred embodiments the mail items 5 comprise letters and parcels.

In this embodiment the postage indicia 7 each include a first postage indicium element 7a which embodies postage information, such as postage value and addressee and sender details. In this embodiment the first postage indicium element 7a is a two-dimensional matrix, typically as specified by a digital indicia postal standard, such as the IBIP standard. In a preferred embodiment the first postage indicium element 7a is cryptographically encoded, such as by encryption or digital signature.

The mail item printing station 3 comprises a printing unit 9 for printing mail items 5 with postage indicia 7, a control unit 11, in this embodiment a microprocessor-based control unit, for controlling the printing unit 9 and performing accounting functions, and a user interface 15 for enabling user control of the mail item printing station 3.

The mail item printing station 3 further comprises a communications unit 17 which provides for communication with a remote center 19, typically a post office center, as will be described in more detail hereinbelow.

The communications unit 17 provides inter alia for the querying of the remote center 19 regarding the status of a mail item 5 from the mail item printing station 3, and the communication of information between the mail item printing station 3 and the remote center 19.

The mail item printing station 3 is configured to enable the application of a service, in this embodiment an insurance service, to any mail item 5, as will be described in more detail hereinbelow.

The control unit 11, in this embodiment a secure module, includes a first memory 21, in this embodiment non-erasable memory, in one embodiment write-once read-many memory (WORM), for logging each event of insurance service as applied to mail items 5, a second memory 22, in this embodiment non-volatile memory (NVM), for storing a value of credit available to be dispensed by the mail item printing station 3, and a third memory 23, in this embodiment non-volatile memory (NVM), for storing insurance service tables.

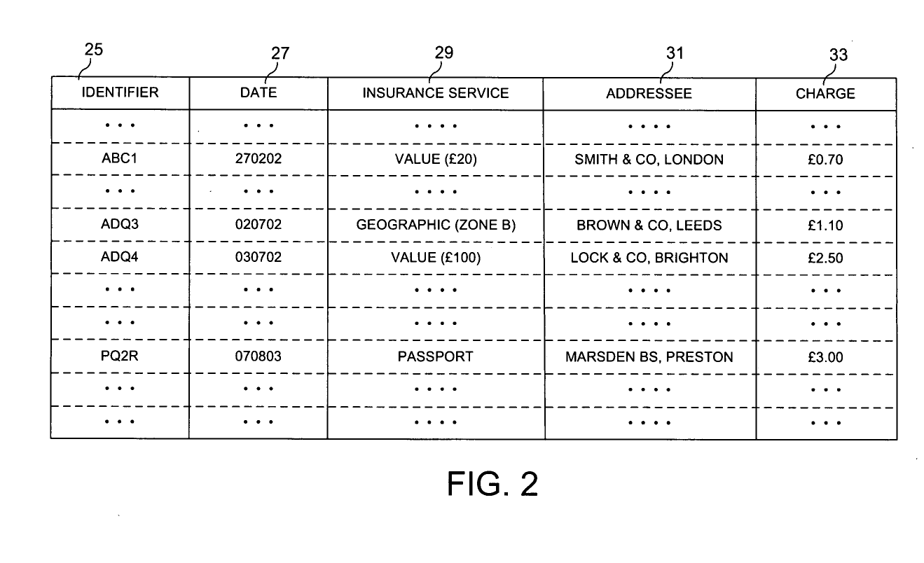

In this embodiment the first memory 21 logs each event of insurance service as applied to mail items 5, such as to provide a record in the event that a claim is to be made in respect of an insured mail item 5. FIG. 2 represents exemplary logged events of the insurance service, where each logged event includes the item identifier 25, the date 27, the insurance service 29, the addressee details 31, and the insurance service charge 33.

In this embodiment the second memory 22 includes a first credit register which is representative of a value of credit available to be dispensed by the mail item printing station 3 in the application of postage charge to mail items 5, and a second credit register which is representative of a value of credit available to be dispensed by the mail item printing station 3 in the application of insurance service charge to mail items 5.

In an alternative embodiment the second memory 22 could include only a single credit register which is representative of a value of credit available to be dispensed by the mail item printing station 3 in the application of both postage charge and insurance service charge to mail items 5.

In this embodiment up-to-date insurance service tables are maintained by the downloading of information from the remote center 19. As will become apparent hereinbelow, the insurance service tables are utilized to determine the insurance service charge for any selected insurance service.

The user interface 15 includes an insurance service option, which, when selected, allows a user to select an insurance service for a mail item 5. In this embodiment insurance can be selected by insured value, for example, £10, £25, £50, etc, by geographic zone, and by kind of insured goods, for example, a passport, a driver's licence, etc, which have a determinable cost for replacement. The user is thus able to select the level of cover by insured value when the value of the goods is known, by geographic zone where a standard level of cover will be provided, unless otherwise specified, and by the kind of goods where the value does not have to be known by the user and the value of replacement is insured by the postal carrier. For the selected insurance service, the insurance service charge is indicated in addition to the normal postage charge, allowing the user to confirm the selected insurance service.

In this embodiment, where an insurance service is selected in respect of a mail item 5, the postage indicium 7 includes a second postage indicium element 7b which is applied to the mail item 5 to designate the application of an insurance service and includes the item identifier 25 for the mail item 5. Through the provision of the second postage indicium element 7b, which identifies the mail item 5 as being insured and requiring confirmation of receipt, the mail delivery person will obtain a signature confirming receipt by the addressee, with the mail item 5 being identified by the item identifier 25 in the second postage indicium element 7b. In this embodiment the signature of the addressee is captured electronically such as to allow for electronic communication to the control center 19. In this embodiment the combined charge of the insurance service charge and the normal postage charge is represented in the first postage indicium element 7a.

In a preferred embodiment the second postage indicium element 7b is a simple code, either in plain text or cryptographically encoded, such as to allow for ready machine reading by mail processing units in the processing of the respective mail item 5.

In normal circumstances, the mail items 5 are delivered to the addressee. However, where a mail item 5 is not received by the addressee and is protected by the insurance service, a user can, from the mail item printing station 3, query the remote center 19 as regards the status of the mail item 5. In addition or alternatively, a user can log a lost item query at the remote center 19 so as to be dealt with by the postal carrier, with the mail item 5 in question being identified from the insurance service record held in the first memory 21 of the control unit 11.

By maintaining a secure record of the insurance service as applied by the mail item printing station 3, the application of an insurance service to a mail item 5 can be authenticated, and the postal carrier is able to authenticate the introduction of the mail item 5 into the mail stream either by having manually logged the mail item 5 on receipt from the user or having automatically logged the mail item 5 where the mail processing system provides for automated reading of mail items 5 in processing the mail items 5.

Where the mail item 5 in question cannot be located, in particular through having no confirmation of receipt by the addressee, as typically obtained by signature on delivery, the postal carrier compensates the user in accordance with the level of insurance cover.

In one embodiment, where the insurance service provides for monetary payment, the insured amount can be applied to the originating mail item printing station 3 as a credit value. In this embodiment the credit value is applied to the second credit register of the second memory 22 of the control unit 11 of the originating mail item printing station 3, which register is representative of the credit available for the application of insurance service.

The mail item handling system further comprises a remote center 19 which is in remote communication with the mail item printing station 3 through the communications unit 17 thereof.

The remote center 19 maintains a record of at least those mail items 5 having an insurance service applied thereto, such as to allow for the status of any of those mail items 5 to be queried. In this embodiment a user, through his/her mail item printing station 3, is able to query the status of a mail item 5.

The remote center 19 also maintains the insurance service tables which are stored in the third memory 23 of the control unit 11 of the mail item printing station 3, in this embodiment by the periodic downloading of new insurance service tables.

Finally, it will be understood that the present invention has been described in its preferred embodiment and can be modified in many different ways without departing from the scope of the invention as defined by the appended claims.

For example, although the embodied mail item handling system has been illustrated for ease of understanding as including only one mail item printing station 3, in other embodiments the mail item handling system can include any number of mail item printing stations 3.

1. A mail item printing station for printing postage indicia on mail items, which postage indicia embody a normal postage service and an additional service for at least ones of the mail items, the printing station comprising:
a printing unit for printing postage indicia on mail items;
a control unit for controlling the printing unit and performing accounting functions, wherein the control unit includes a first memory for logging each event of the additional service as applied to the at least ones of the mail items; and
a user interface for enabling user control of the printing station.

2. The printing station of claim 1, wherein each logged event includes a mail item identifier.

3. The printing station of claim 1, wherein each logged event identifies a selected additional service.

4. The printing station of claim 1, wherein the first memory is a non-erasable memory.

5. The printing station of claim 1, wherein the control unit includes a second memory for storing a value of credit to be dispensed by the printing station.

6. The printing station of claim 5, wherein the second memory comprises a first credit register which is representative of a value of credit available to be dispensed by the printing station in application of a normal postage charge in accordance with the normal postage service, and a second credit register which is representative of a value of credit available to be dispensed by the printing station in application of an additional service charge in accordance with the additional service.

7. The printing station of claim 5, wherein the second memory comprises a single credit register which is representative of a value of credit available to be dispensed by the printing station in application of both a normal postage charge in accordance with the normal postage service and an additional service charge in accordance with the additional service.

8. The printing station of claim 1, wherein the control unit includes a third memory for storing at least one table defining additional service charges for the additional service.

9. The printing station of claim 1, wherein the additional service comprises an insurance service by which mail items are insured.

10. The printing station of claim 9, wherein the insurance service can be selected by insured value.

11. The printing station of claim 9, wherein the insurance service can be selected by geographic zone.

12. The printing station of claim 9, wherein the insurance service can be selected by kind of insured goods, thereby not requiring the user to provide an indication as to value of replacement of the goods.

13. The printing station of claim 1, wherein the postage indicia embodying a normal postage service and an additional service each comprise first and second postage indicium elements, the first postage indicium element embodying normal postage information and the second postage indicium element embodying application of the additional service.

14. The printing station of claim 13, wherein the second postage indicium element includes an identifier for the mail item.

15. The printing station of claim 13, wherein the second postage indicium element is cryptographically encoded.

16. A mail item handling system, comprising:
at least one printing station of claim 1.

17. The system of claim 16, wherein the at least one printing station comprises a communications unit, and further comprising:
a control center in communication with the at least one printing station, the control center maintaining a record of at least the mail items having the additional service applied thereto.

18. The system of claim 17, wherein the at least one printing station is configured to allow a user to query the control center as regards a status of a mail item.

19. A method of handling mail items, comprising the steps of:
providing a mail item printing station for printing postage indicia on mail items, wherein the printing station is operable, for any mail item, to allow a user to select an additional service in addition to a normal postage service;
selecting an additional service for a mail item;
logging the additional service as applied to the mail item; and
printing a postage indicium on the mail item, which postage indicium embodies the normal postage service and the additional service.

20. The method of claim 19, wherein each logged event includes a mail item identifier.

21. The method of claim 19, wherein each logged event identifies a selected additional service.

22. The method of claim 19, wherein the logged events are logged in a non-erasable memory, such as to provide for authentication of the logged events.

23. The method of claim 19, further comprising the step of:
storing a value of credit available to be dispensed by the printing station.

24. The method of claim 23, wherein the credit value storing step comprises the steps of:
storing a first value of credit available to be dispensed by the printing station in application of a normal postage charge in accordance with the normal postage service; and
storing a second value of credit available to be dispensed by the printing station in application of an additional service charge in accordance with the additional service.

25. The method of claim 19, further comprising the step of:
storing at least one table defining additional service charges for the additional service.

26. The method of claim 19, wherein the additional service comprises an insurance service by which mail items are insured.

27. The method of claim 26, wherein the insurance service can be selected by insured value.

28. The method of claim 26, wherein the insurance service can be selected by geographic zone.

29. The method of claim 26, wherein the insurance service can be selected by kind of insured goods, thereby not requiring the user to provide an indication as to value of replacement of the goods.

30. The method of claim 19, wherein the postage indicia embodying a normal postage service and an additional service each comprise first and second postage indicium elements, the first postage indicium element embodying normal postage information and the second postage indicium element embodying application of the additional service.

31. The method of claim 30, wherein the second postage indicium element includes an identifier for the mail item.

32. The method of claim 30, wherein the second postage indicium element is cryptographically encoded.

33. The method of claim 19, further comprising the step of:
maintaining at a control center a record of at least the mail items having the additional service applied thereto.

34. The method of claim 33, wherein the printing station is configured to allow a user to query the control center as regards a status of a mail item.
